(19) United States
(12) Patent Application Publication
(10) Pub. No.: US 2007/0228252 A1
(43) Pub. Date: Oct. 4, 2007

(54) Fixing device

(75) Inventor: Tsung-Bin Tsai, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/398,034

(22) Filed: Apr. 4, 2006

(51) Int. Cl. F16M 5/00

(52) U.S. Cl. 248/671

(57) ABSTRACT

A fixing device for fixing a heat sink in an electronic device is proposed. The fixing device includes a first fixing member and a second fixing member both for being mounted to the electronic device. The first fixing member and the second fixing member respectively further include a first fixing portion and a second fixing portion both for fixing two surfaces of the heat sink, and a first connecting portion and a second connecting portion, allowing the second connecting portion of the fixing device to be coupled to the first connecting portion of another fixing device mounted to another heat sink, so as to connect at least two heat sinks to each other. Therefore, the fixing device can be provided according to the number of required heat sinks, so as to eliminate prior-art drawbacks.

### FIELD OF THE INVENTION

The present invention relates to a technique for fixing a heat sink, and more particularly, to a fixing device for fixing a heat sink in a case of an electronic device.

### BACKGROUND OF THE INVENTION

A heat sink such as a fan is usually provided in a case of an electronic device such as a server, a computer, etc., so as to prevent abnormal operation of the system caused by an excessively high temperature during the operation. As the amount of heat needing to be dissipated has gradually gone up with higher clock speeds and higher integration, larger or multiple heat sinks are often required and such heat sinks often employ fans. Also, as a fan may need to be replaced due to a breakdown after being used over a period of time, the fan is usually installed in the case of the electronic device using a detachable method.

Take the example of an electronic device such as a server, a number of fans are usually provided in the server case having a number of spaces. Then, the case is fixed in a cabinet to achieve heat dissipation. Taiwan Patent No. 584264 and No. 578995 have both disclosed relevant techniques.

Referring to the foregoing prior-art technique, a number of fans are usually provided in a case. However, when the amount of heat generated does not require the case to be fully installed with fans, the space reserved for fans is wasted. In other words, the foregoing patents are unable to design the space of the case according to the number of fans. Thus, the case tends to occupy the limited space of the electronic device, such that the expandability of the server can be impaired by such an inflexible design. Furthermore, referring to Taiwan Patent No. 584264, which discloses a method for fixing the fan in the case using tools, the requirement for tools is a limiting factor and the detachment process can be time-consuming. Additionally, referring to Taiwan Patent No. 578995, the fixing element being disclosed is very complex in structure and the alignment process during assembly is very difficult. Moreover, when a large number of elements are used inside the case of the server and thus occupying the limited space of the electronic device, the detachment process is especially difficult, regardless of whether using tools during assembly/disassembly or not. Therefore, it is desirable to focus on ways to eliminate such drawbacks.

Moreover, if the foregoing prior-art fixing device is damaged, the overall structure needs to be replaced and other elements cannot be re-used, so that the maintenance of the electronic device is very cost-ineffective. Also, as the assembly process required after elements are replaced is very complex, the production cost and the difficulty of the assembling process are increased as a consequence.

What is needed, therefore, is to provide a fixing device that can be designed according to the number of required heat sinks while being characterized with a simple and quick detachment process that can reduce production costs by either reducing required materials or labor.

### SUMMARY OF THE INVENTION

In light of the above prior-art drawbacks, a primary objective of the present invention is to provide a fixing device that can be designed according to the number of required heat sinks, so as to flexibly use the space of an electronic device.

Another objective of the present invention is to provide a fixing device that does not require any tools for the detachment process, by which the detachment process can be completed immediately.

A further objective of the present invention is to provide a fixing device that allows partial replacement, so as to reduce maintenance costs.

In accordance with the foregoing and other objectives, the present invention proposes a fixing device for fixing a heat sink in an electronic device. The fixing device comprises a first fixing member for being mounted to the electronic device, the first fixing member comprising a first surface, a second surface, a first fixing portion formed on the first surface of the first fixing member and for fixing a surface of the heat sink, and a first connecting portion formed on the second surface of the first fixing member; and a second fixing member for being mounted to the electronic device, the second fixing member comprising a first surface, a second surface, a second fixing portion formed on the first surface of the second fixing member and for fixing another surface of the heat sink, and a second connecting portion formed on the second surface of the second fixing member, allowing the second connecting portion of the fixing device to be coupled to the first connecting portion of another fixing device that is mounted on another heat sink so as to connect at least two heat sinks to each other.

More preferably, the first fixing member can further comprise a first body having the corresponding first surface and second surface. Similarly, the second fixing member also comprises a second body having the corresponding first surface and second surface. In a preferred embodiment, the first body and the second body respectively comprise a first attaching portion and a second attaching portion for attaching the electronic device. The first attaching portion and the second attaching portion can be bases that can be formed with openings for assembling the electronic device. The first fixing member and the second fixing member can respectively comprise a plurality of first fixing portions and a plurality of second fixing portions which can be posts or other equivalent structures for fixing the heat sink. In a preferred embodiment, the first connecting portion is a dovetail block and the second connecting portion is a dovetail groove. In another preferred embodiment, the first connecting portion is a dovetail groove and the second connecting portion is a dovetail block.

In accordance with the foregoing and other objectives, the present invention also proposes a fixing device for fixing at least two heat sinks in an electronic device. The fixing device comprises at least two first fixing members for being mounted to the electronic device, each of the first fixing members comprising a first surface, a second surface, a first fixing portion formed on the first surface of each of the first fixing members, and a first connecting portion formed on the second surface of each of the first fixing members, allowing the first fixing portions of the first fixing members to fix two surfaces of one of the heat sinks; and at least two second fixing members for being mounted to the electronic device, each of the second fixing members comprising a first surface, a second surface, a second fixing portion formed on the first surface of each of the second fixing members, and a second connecting portion formed on the second surface of each of the second fixing members, allowing the second fixing portions of the second fixing members to fix two surfaces of another one of the heat sinks, and allowing the second connecting portion of at least one of the second fixing members to be coupled to the first connecting portion of at least one of the first fixing members so as to connect the at least two heat sinks to each other.

In the foregoing fixing device, the first fixing member can further comprise a first body having the corresponding first surface and second surface. Similarly, the second fixing member can comprise a second body having the corresponding first surface and second surface. In a preferred embodiment, the first body and the second body respectively comprise a first attaching portion and a second attaching portion for attaching the electronic device. The first attaching portion and the second attaching portion can be bases that can be formed with openings for assembling the electronic device. The first fixing member and the second fixing member can respectively comprise a plurality of first fixing portions and a plurality of second fixing portions, which can be posts or other equivalent structures for fixing the heat sink. In a preferred embodiment, the first connecting portion is a dovetail block and the second connecting portion is a dovetail groove. In another preferred embodiment, the first connecting portion is a dovetail groove and the second connecting portion is a dovetail block.

Due to the design of the connection of the first connecting portion and the second connecting portion, the fixing device proposed in the present invention can be designed depending on the number of heat sinks required by the electronic device. Thus, in comparison to the prior-art technique, the fixing device proposed in the present invention is able to eliminate the drawback that the limited space of the electronic device is occupied by the space provided for heat sinks. Also, the fixing device proposed in the present invention does not require any tools to perform a detachment process, such that the difficulties encountered in performing the detachment process that occurred in the prior-art technique can be eliminated, and the detachment process can be quickly performed by a user. Further, as the present invention proposes a detachable fixing device which can be conveniently operated, an assembling process can be easily performed and partial replacement can be achieved according to which part of the fixing device is aged or damaged, for example, the first fixing member or the second fixing member. Therefore, the prior-art problem regarding high maintenance costs caused by the required replacement of the overall structure can be solved, so as to reduce the maintenance cost and improve industrial applicability.

Accordingly, the fixing device proposed in the present invention can be designed according to the number of required heat sinks, so as to flexibly use the space of the electronic device. Moreover, the fixing device proposed in the present invention does not require any tools to perform the detachment process, so as to simplify the assembly process, shorten the time required for the assembly process, and reduce maintenance costs. Therefore, the present invention is able to eliminate prior-art drawbacks and improve industrial utilization.

### BRIEF DESCRIPTION OF THE DRAWINGS

The present invention can be more fully understood by reading the following detailed description of the preferred embodiments, with reference made to the accompanying drawings, wherein:

FIG. 1 is an exploded view of a fixing device for fixing a heat sink according to a preferred embodiment of the present invention;

FIG. 2A and FIG. 2B are perspective diagrams showing the structure of a first fixing member according to FIG. 1;

FIG. 3A and FIG. 3B are perspective diagrams showing the structure of a second fixing member according to FIG. 1; and

FIG. 4A and FIG. 4B are perspective diagrams showing an assembly of a fixing device and a heat sink according to FIG. 1.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

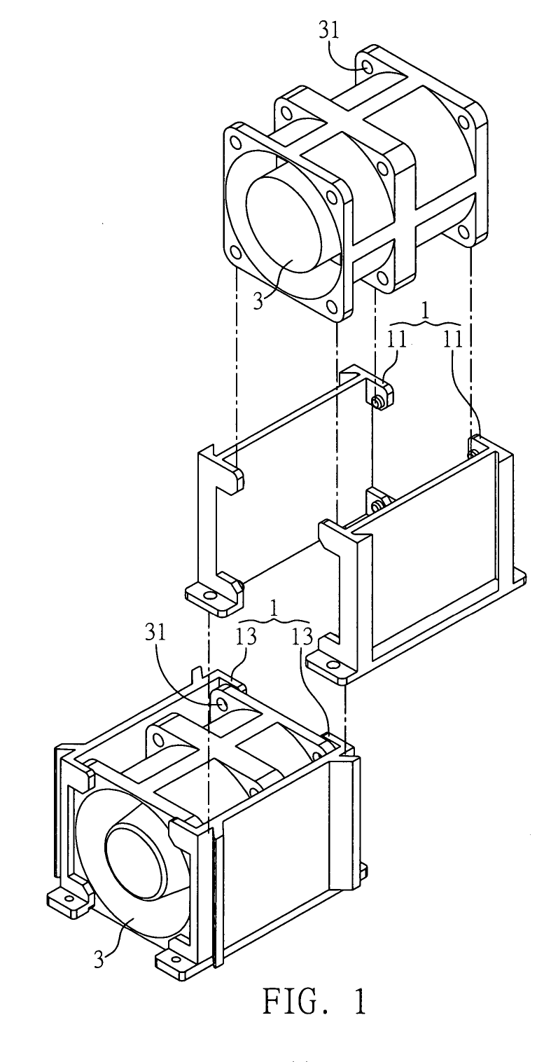

FIG. 1 to FIG. 4B are perspective diagrams showing a fixing device 1 according to a preferred embodiment of the present invention. Referring to FIG. 1, the fixing device 1 comprises a first fixing member 11 and a second fixing member 13. Also, as shown in FIG. 1, the fixing device 1 proposed in the present invention serves to fix a heat sink 3 in an electronic device (not shown in the figure). The heat sink 3 comprises a buttonhole 31. A fan for an electronic device such as a server serves to provide further description of the heat sink 3 in the following embodiments, but the scope of the invention is not limited by the fan.

Note that the present invention may not only be applied to the foregoing server but also to other electronic devices with heat sinks. As the structure is consistent and in order to emphasize the characteristics and structures of the present invention, only structures directly relevant to the present invention are illustrated. Also, FIG. 1 is a simplified perspective diagram, and thus only basic structures relevant to the present invention are illustrated. Furthermore, these structures are not drawn according to actual amount, shapes and dimensions. The amount, shapes and dimensions are design decisions and the arrangements of the structures may be more complicated in actual application.

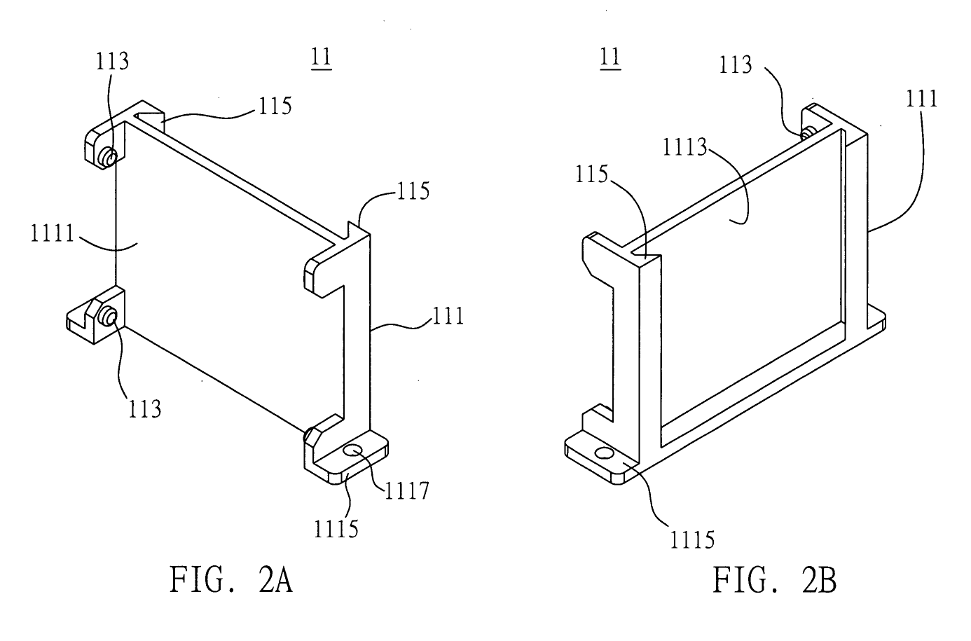

Referring to FIG. 2A and FIG. 2B, the first fixing member 11 comprises a first body 111, a plurality of first fixing portions 113, and a plurality of first connecting portions 115.

The first body 111 can be a plate structure designed according to the length of the heat sink 3. In the present embodiment, the first body 111 comprises a first surface 1111 for fixing the heat sink 3 and a second surface 1113 for attaching the second fixing member 13 (described subsequently). Note that the first body 111 of the present embodiment can be a rectangle that can be connected to the heat sink 3. However, the shape of the first body 111 can be easily modified by one skilled in the pertinent art, as long as the requirement of fixing the heat sink 3 can be met. In that such a modification can easily be achieved, it will not be further described.

Moreover, in the present embodiment, the first body 111 further comprises a first attaching portion 1115 for attaching with the electronic device. The first attaching portion 1115 can be a base that can be formed with an opening 1117 for attaching the electronic device. The dimensions of the first attaching portion 1115 and the structure thereof for attaching the electronic device (i.e. the opening 1117) are not limited by the disclosure of the present embodiment.

Referring to FIG. 2A and FIG. 2B, the first fixing portion 113 is formed on a first surface 1111 of the first body 111 for fixing the heat sink 3. In the present embodiment, the first fixing portion 113 is a post located at a position corresponding to the buttonhole 31 of the heat sink 3, and four such first fixing portions 113 are provided. However, each of the first fixing portions 113 can be modified by one skilled in the pertinent art according to the structure of the buttonhole 31 of the heat sink 3. In other words, the first fixing portion 113 can be another equivalent structure for fixing the heat sink 3, and the number of the first fixing portions 113 can be varied.

The first connecting portion 115 is formed on the second surface 1113 of the first body 111 for connecting the second fixing member 13. In the present embodiment, the first connecting portion 115 is a dovetail groove but is not limited by the dovetail groove. Further, the first connecting portion 115 can be successively formed on two sides of the second surface 1113 of the first body 111. However, the first connecting portion 115 can also be a discrete dovetail groove or other grooves having similar shapes, provided that the first connecting portion 115 can be connected to the second fixing member 13 to achieve a fixing function.

In other words, in application, the first connecting portion 115 can be provided at four corners of the second surface 1113 of the first body 111. Alternatively, instead of the whole side of the second surface 1113, the first connecting portion 115 can be partially provided on two sides of the second surface 1113 of the first body 111. Such modification is not limited by the present figure and can be easily understood by one skilled in the pertinent art, and thus further description or drawings will not be provided.

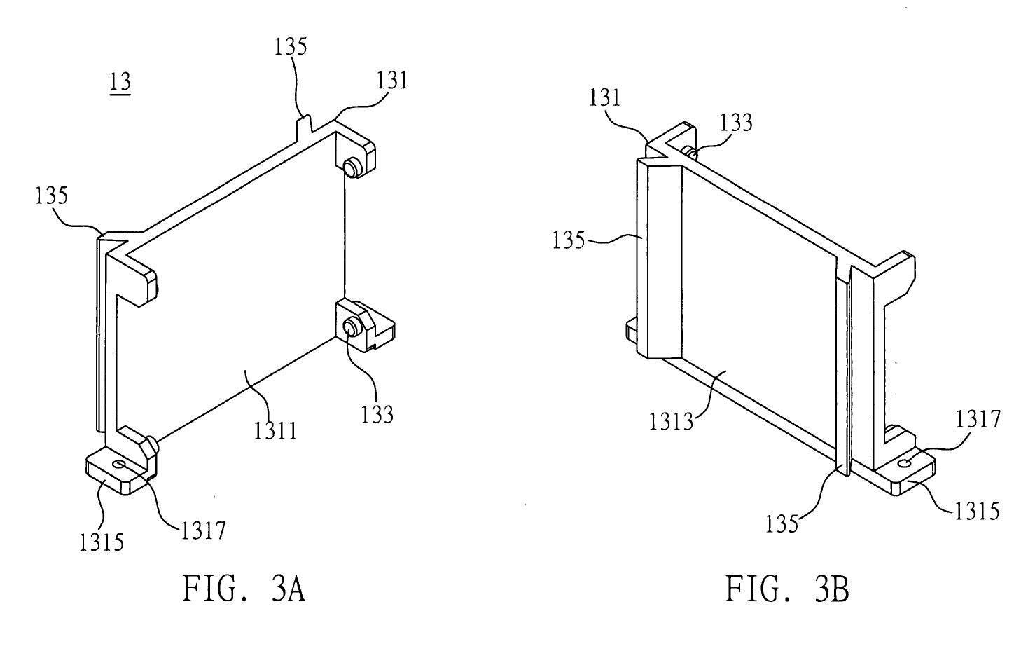

Referring to FIG. 3A and FIG. 3B, the second fixing member 13 comprises a second body 131, a plurality of second fixing portions 133 and a plurality of second connecting portions 135.

The second body 131 can be a plate structure that is similar to the first body 111 and can be designed according to the length of the heat sink 3. In the present embodiment, the dimensions of the second body 131 are consistent with that of the first body 111, and the second body 131 comprises a first surface 1311 for fixing the heat sink 3 and a second surface 1313 for attaching the first fixing member 11 (described previously).

Note that the second body 131 of the present embodiment can be a rectangle that can be connected to the heat sink 3. However, the shape of the second body 131 can be easily modified by one skilled in the pertinent art. Moreover, in the present embodiment, the shape and dimensions of the second body 131 are consistent with those of the first body 111. However, the shape and dimensions of the second body 131 can differ from those of the first body 111 in other embodiments, as long as the requirement of fixing the heat sink 3 can be met. Thus, such modifications can be achieved by one skilled in the pertinent art according to practical requirements.

Moreover, in the present embodiment, the second body 131 further comprises a second attaching portion 1315 for attaching with the electronic device. The second attaching portion 1315 can be a base that can be formed with an opening 1317 for attaching the electronic device. The dimensions of the second attaching portion 1315 and the structure thereof for attaching the electronic device (i.e. the opening 1317) are not limited by the disclosure of the present embodiment.

Referring to FIG. 3A and FIG. 3B, the second fixing portion 133 is formed on the first surface 1311 of the second body 131 for fixing the heat sink 3. In the present embodiment, the second fixing portion 133 is a post located at a position corresponding to the buttonhole 31 of the heat sink 3, and four second fixing portions 133 are provided. However, each of the second fixing portions 133 can be modified according to the structure of the buttonhole 31 of the heat sink 3 by one skilled in the pertinent art. In other words, the second fixing portion 133 can be another equivalent structure as long as it is able to fix the heat sink 3, and the number of the second fixing portions 133 can also be varied.

The second connecting portion 135 is formed on the second surface 1313 of the second body 131 for connecting the first fixing member 11. In the present embodiment, the second connecting portion 135 is a dovetail groove but is not limited by the dovetail groove. Further, the second connecting portion 135 can be successively formed on two sides of the second surface 1313 of the second body 131. However, the second connecting portion 135 can also be a discrete dovetail groove or other grooves having similar shapes, provided that the second connecting portion 135 can be attached to the first connecting portion 115 of the first fixing member 11 to provide a fixing function.

In other words, in application, the second connecting portion 135 can be provided at corners of the second surface 1313 of the second body 131. Alternatively, instead of the whole side of the second surface 1313, the second connecting portion 135 can be partially provided on two sides of the second surface 1313 of the second body 131 (approximately at a middle position). The figure in the present embodiment only serves as an example to provide description. Moreover, in the present embodiment, the first connecting portion 115 formed on the first fixing member 11 can be a dovetail groove, and the second connecting portion 135 formed on the second fixing member 13 can be a dovetail block. However, the first connecting portion 115 formed on the first fixing member 11 can also be a dovetail block, and the second connecting portion 135 formed on the second fixing member 13 can be a dovetail groove. In other words, the structures of the first connecting portion 115 and the second connecting portion 135 can be reversed, provided that both of the structures are able to correspondingly connect to each other.

Furthermore, in other embodiments, the first connecting portion 115 formed on one side of the first fixing member 11 can be a dovetail block and the first connecting portion formed on another side of the first fixing member 11 can be a dovetail groove. Also, the second connecting portions 135 formed on the second fixing member 13 are respectively a dovetail groove and a dovetail block for correspondingly connecting the first connecting portions 115. In other words, the first connecting portion 115 formed on the first fixing member 11 and the second connecting portion 135 formed on the second fixing member 13 can be respectively a dovetail block and a dovetail groove, provided that the structures can be connected to each other. As one skilled in the pertinent art is able to modify the structures of the first connecting portion 115 and the second connecting portion 135 with other equivalent structures, further description and drawings of such modification will not be provided.

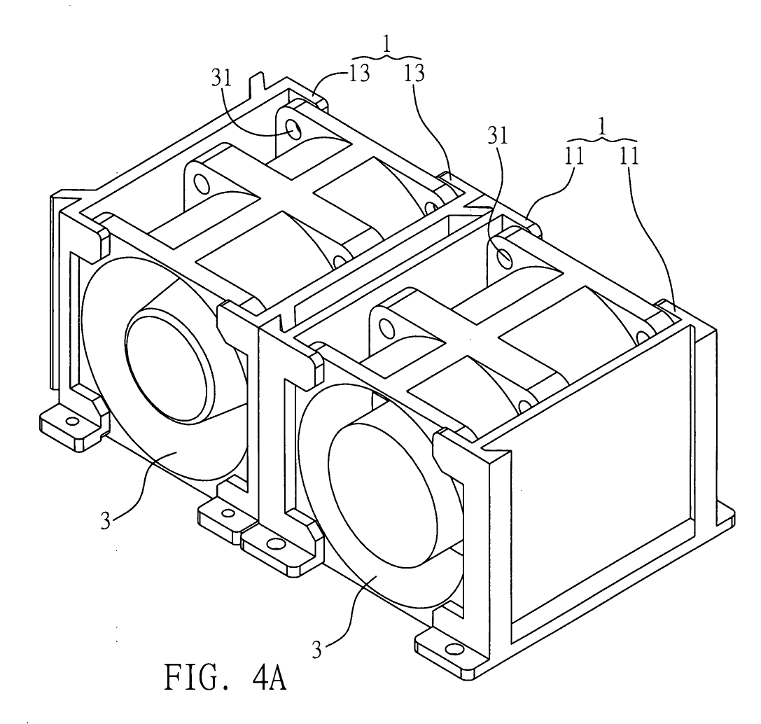

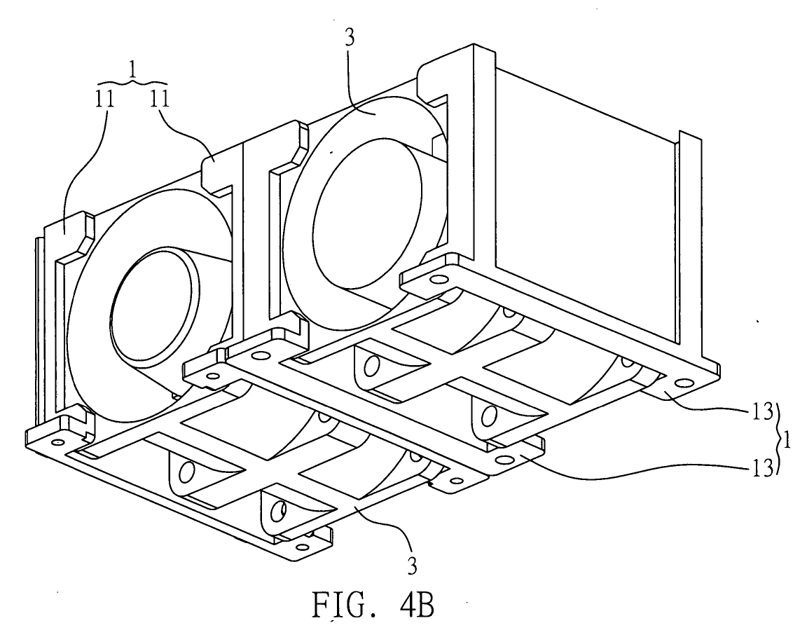

When the fixing device 1 is used to attach the heat sink 3 to the electronic device, only the first fixing member 11 and the second fixing member 13 of the fixing device 1 need to be attached to the heat sink 3 before the fixing device 1 is attached to the electronic device. In the present embodiment, the first fixing portion 113 of the first fixing member 11 and the second fixing portion 133 of the second fixing member 13 serve to locate the buttonhole 31 of the heat sink 3, such that the assembly process in which one of the heat sinks 3 is attached using the fixing device 1 can be completed. Subsequently, the foregoing assembly process can be repeated. Lastly, with a pair of the fixing devices 1 being completed with the foregoing assembly process, they can be connected to each other. Thus, the assembly process can be performed without the requirement of tools. The structure being completed with the assembling process is shown in FIG. 4A and FIG. 4B.

The foregoing assembly process only serves as an example for the present invention without limiting the scope of the present invention. For example, two of the first fixing portions 113 of the first fixing member 11 can be firstly used to locate the buttonhole 31 of one heat sink 3. Then, two of the second fixing portions 133 of the second fixing member 13 serve to locate the buttonhole 31 of another heat sink 3. The heat sink 3 fixed by the first fixing member 11 is subsequently attached to the heat sink 3 fixed by the second fixing member 13. Thus, all of the assembly processes can be completed without the use of tools if the foregoing assembly process can be repeatedly performed, the structure being completed with the assembly process being shown in FIG. 4A and FIG. 4B, as previously mentioned. Additionally, when the fixing device 1 is to be detached from the heat sink 3, only the foregoing assembling processes need to be performed in reverse, so as not to require the use of any tools.

Moreover, the first fixing member 11 and the second fixing member 13 of the fixing device 1 can be initially attached to one of the heat sinks 3. Then, a number of fixing devices 1 being fixed with heat sinks 3 can be provided in the electronic device. In such embodiment, the first fixing portion 113 of the first fixing member 11 and the second fixing portion 133 of the second fixing member 13 serve to locate the buttonhole 31 of the heat sink 3, such that a single assembly process for fixing the heat sink 3 using one fixing device 1 can be completed. Then, the foregoing assembly process can be repeatedly performed. Lastly, the fixing devices 1 being completed with the foregoing assembly processes can be attached to each other, such that the use of tools is not necessary.

Via the design of the connection of the first connecting portion and the second connecting portion, the fixing device proposed in the present invention can be flexibly designed depending on the number of heat sinks required by the electronic device. Thus, in comparison to the prior-art technique, the present invention is able to adjust the number of fixing devices depending on practical requirements, so as to flexibly and efficiently use the space of the electronic device. Also, the fixing device proposed in the present invention does not require the use of any tools to fix the heat sink and to detach the heat sink, such that both of the assembly process and the detachment process can be readily performed. Moreover, instead of replacement of the overall fixing device in the prior-art technique, the fixing device proposed in the present invention allows partial replacement of the fixing device depending on the practical requirements. For example, only one of the first fixing member and the second fixing member or one of a plurality of fixing devices needs to be replaced depending on practical requirement. Therefore, prior-art drawbacks can be eliminated and maintenance costs can be reduced and industrial applicability can be improved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A fixing device for fixing a heat sink in an electronic device, the fixing device comprising:
a first fixing member for being mounted to the electronic device, the first fixing member comprising a first surface, a second surface, a first fixing portion formed on the first surface of the first fixing member and for fixing a surface of the heat sink, and a first connecting portion formed on the second surface of the first fixing member; and
a second fixing member for being mounted to the electronic device, the second fixing member comprising a first surface, a second surface, a second fixing portion formed on the first surface of the second fixing member and for fixing another surface of the heat sink, and a second connecting portion formed on the second surface of the second fixing member, allowing the second connecting portion of the fixing device to be coupled to the first connecting portion of another fixing device that is mounted on another heat sink so as to connect at least two heat sinks to each other.

2. The fixing device of claim 1, wherein the first fixing member further comprises a first body having the first surface and the second surface thereof, and the second fixing member further comprises a second body having the first surface and the second surface thereof.

3. The fixing device of claim 2, wherein the first body and the second body respectively further comprise a first attaching portion and a second attaching portion both for being attached to the electronic device.

4. The fixing device of claim 3, wherein the first attaching portion and the second attaching portion are each a base formed on a bottom surface of the first body and a bottom surface of the second body respectively, and the base is formed with an opening.

5. The fixing device of claim 1, wherein the first connecting portion is a dovetail block and the second connecting portion is a dovetail groove.

6. The fixing device of claim 1, wherein the first connecting portion is a dovetail groove and the second connecting portion is a dovetail block.

7. A fixing device for fixing at least two heat sinks in an electronic device, the fixing device comprising:
at least two first fixing members for being mounted to the electronic device, each of the first fixing members comprising a first surface, a second surface, a first fixing portion formed on the first surface of each of the first fixing members, and a first connecting portion formed on the second surface of each of the first fixing members, allowing the first fixing portions of the first fixing members to fix two surfaces of one of the heat sinks; and
at least two second fixing members for being mounted to the electronic device, each of the second fixing members comprising a first surface, a second surface, a second fixing portion formed on the first surface of each of the second fixing members, and a second connecting portion formed on the second surface of each of the second fixing members, allowing the second fixing portions of the second fixing members to fix two surfaces of another one of the heat sinks, and allowing the second connecting portion of at least one of the second fixing members to be coupled to the first connecting portion of at least one of the first fixing members so as to connect the at least two heat sinks to each other.

8. The fixing device of claim 7, wherein each of the first fixing members further comprises a first body having the first surface and the second surface thereof, and each of the second fixing members further comprises a second body having the first surface and the second surface thereof.

9. The fixing device of claim 8, wherein the first body and the second body respectively comprise a first attaching portion and a second attaching portion both for being attached the electronic device.

10. The fixing device of claim 9, wherein the first attaching portion and the second attaching portion are each a base formed on a bottom surface of the first body and a bottom surface of the second body respectively, and the base is formed with an opening.

11. The fixing device of claim 7, wherein the first connecting portion is a dovetail block and the second connecting portion is a dovetail groove.

12. The fixing device of claim 7, wherein the first connecting portion is a dovetail groove and the second connecting portion is a dovetail block.
